(19) United States
(12) Patent Application Publication
(10) Pub. No.: US 2007/0160802 A1
(43) Pub. Date: Jul. 12, 2007

(54) Controlled compounding of thermoplastic polymer composition with barrier properties

(76) Inventor: Olivier Rozant, Cernex (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/641,308

(22) Filed: Dec. 19, 2006

Related U.S. Application Data
(60) Provisional application No. 60/751,812, filed on Dec. 20, 2005.

(51) Int. Cl. B32B 5/00; C08G 63/91

(52) U.S. Cl. 428/98; 264/176.1; 525/56; 525/178

(57) ABSTRACT

The invention provides a method for compounding olefin resins with barrier resins to produce thermoplastic polymer blends that can be used to make molded or extruded articles having barrier properties to organic solvents.

This application claims the benefit of U.S. Provisional Application No. 60/751,812, filed Dec. 20, 2005.

### FIELD OF THE INVENTION

The invention relates to the field of thermoplastic polymers, particularly thermoplastic polymer blends having barrier properties to hydrocarbons.

### BACKGROUND OF THE INVENTION

It is known to add minor quantities (e.g. 4 wt % to 15 wt %) of barrier resins such as polyvinyl alcohol, copolymers of ethylene-vinyl alcohol or polyamides to polyolefin resins such as high density polyethylene (HDPE), low density polyethylene (LDPE), and polypropylene (PP) to improve the solvent and hydrocarbon barrier performance of the olefin in blow-molded applications. Examples of such barrier resins are sold under the tradename Selar® RB (DuPont).

The barrier resin is added to the polyolefin resin as a dry blend, which is then mixed in an extruder. Processing to make hollow articles is done on conventional extrusion blow-molding machines. The resulting blow-molded containers are economical, lightweight, impact resistant, and can be formed into a wide variety of complex shapes.

Uses of such olefin resins with enhanced barrier properties include automotive fuel tanks, small, permeation-resistant fuel tanks and other service fluid and solvent storage containers. Applications include lawn and garden equipment and lightweight vehicles such as personal watercraft, ATVs, motorcycles and golf carts, whose manufacturers need to reduce air emissions of hydrocarbons to meet environmental regulations.

Although such barrier-enhanced olefin resins have excellent properties, a need remains for olefin resins having improved barrier properties.

### SUMMARY OF THE INVENTION

The inventors have found that when a barrier resin and an olefin resin are compounded using a controlled temperature profile, molded and extruded products with enhanced barrier properties to hydrocarbons can be produced.

In a first aspect, the invention provides a method for producing a thermoplastic polymer blend having barrier properties to hydrocarbons, the method comprising the steps:

blending in an extruder thermoplastic polymer material comprising or consisting essentially of an olefin resin, and a barrier resin selected from polyvinyl alcohol, copolymers of ethylene-vinyl alcohol, polyamides, and mixtures of these, wherein the temperature of the thermoplastic polymer material in the extruder is controlled to be not higher than at or about 10° C. above the melting point of the barrier resin.

In a second aspect, the invention provides a molded or extruded article comprising or consisting essentially of a thermoplastic polymer blend comprising or consisting essentially of a polyolefin and a barrier resin selected from polyvinyl alcohol, copolymers of ethylene-vinyl alcohol, polyamides, and mixtures of these, wherein the molded or extruded article has a permeability to hydrocarbons at a wall thickness (t) of 1.4 mm, and an external area (A) of 645 cm², of less that at or about 0.0787 g·mm/day·100 cm², when a steady rate of mass transfer of hydrocarbon is reached, as measured according to ASTM D2684 [fuel type CE10; temperature 40° C.].

In a third aspect, the invention provides a molded or extruded article comprising or consisting essentially of a thermoplastic polymer blend comprising or consisting essentially of a polyolefin and a barrier resin selected from polyvinyl alcohol, copolymers of ethylene-vinyl alcohol, polyamides, and mixtures of these, wherein the molded or extruded article has a laminar microstructure exhibiting an aspect ratio of greater than at or about 10.

In a fourth aspect, the invention provides a molded or extruded article made by a method comprising a step of blending in an extruder thermoplastic polymer material comprising or consisting essentially of an olefin resin and a barrier resin selected from polyvinyl alcohol, copolymers of ethylene-vinyl alcohol and polyamides, and mixtures of these, wherein the temperature of the thermoplastic polymer material in the extruder is controlled to be not higher than at or about 10° C. above the melting point of the barrier resin.

In a fifth aspect, the invention provides a method for producing a molded or extruded article comprising a thermoplastic polymer blend having barrier properties to hydrocarbons, the method comprising the steps:

blending in an extruder thermoplastic polymer material comprising or consisting essentially of an olefin resin, and a barrier resin selected from polyvinyl alcohol, copolymers of ethylene-vinyl alcohol, polyamides, and mixtures of these; and

molding or extruding the thermoplastic polymer material;

wherein the temperature of the thermoplastic polymer material in the extruder is controlled to be not higher than at or about 10° C. above the melting point of the barrier resin.

### DETAILED DESCRIPTION OF PREFERRED EMBODIMENTS

### Description of the Drawings

FIG. 1 is a schematic depiction of an extruder for blow molding.

FIG. 2 shows the temperature profiles used for the compounding and blow-molding of test bottles with barrier resin consisting of an ethylene-vinyl alcohol copolymer (EVOH), with at or about 26 mol % of repeat units derived from ethylene and at or about 74 mol % derived from vinylalcohol, and the following compatibilizers: maleic anhydride grafted HDPE, or maleic anhydride grafted ethylene propylene diene (EPDM). This barrier resin has a melting point of approximately 195° C.

FIG. 3 shows the permeability results for blow-molded standard test bottles made in comparative run 20 and runs 9, 15 and 16, according to the invention.

FIG. 4 shows an enlargement of runs 9, 15 and 16, from FIG. 3. FIG. 5 shows schematically polymer blend microtomes having different aspect ratios.

### ABBREVIATIONS

HDPE: high-density polyethylene
LDPE: low density polyethylene
PP: polypropylene
EVOH: ethylene-vinyl alcohol copolymer
PA6: nylon 6, a polyamide made by polymerizing caprolactam
PA66: nylon 6,6, a polyamide made by polymerizing adipic acid and hexamethylene diamine
PVOH: polyvinyl alcohol

The method of the invention involves a step of blending in an extruder thermoplastic polymer material comprising or consisting essentially of an olefin resin and a barrier resin selected from polyvinyl alcohol, copolymers of ethylene-vinyl alcohol, polyamides, and mixtures of these, wherein the temperature of the thermoplastic polymer material in the extruder is controlled to be not higher than at or about 10° C. above the melting point of the barrier resin.

Preferred polyolefin resins are selected from high-density polyethylene (HDPE), low density polyethylene (LDPE) and polypropylene (PP), and mixtures of these. The method of the invention is particularly suited to HDPE.

The barrier resin is selected from polyvinyl alcohol, copolymers of ethylene-vinyl alcohol, polyamides, and mixtures of these. Preferred barrier resins are ethylene vinyl alcohol copolymers (EVOH), particularly with at or about 20 to 40 mol % of repeat units derived from ethylene, and at or about 60 to 80 mol % of repeat units derived from vinyl alcohol, more preferably at or about 24 to 36 mol % of repeat units derived from ethylene, and at or about 64 to 76 mol % of repeat units derived from vinyl alcohol. Also contemplated are mixtures of such polymers and copolymers.

The barrier resin may additionally comprise a compatibilizer at from at or about 15 to 50 wt %, preferably at or about 20 to 45 wt %, more preferably at or about 25 to 40 wt %, based on the weight of polymers in the barrier resin. Examples of compatibilizers include maleic anhydride grafted HDPE, or maleic anhydride grafted ethylene propylene diene (EPDM).

Also preferred as barrier resin is PA6, PA6,66, and mixtures of these. Also preferred are PA6 and/or PA6,66 in combination with PVOH, particularly PA6,66 in combination with PVOH, wherein the weight percent of PVOH is at or about 20 to 50 wt %, more preferably at or about 30 to 45 wt %, particularly preferably at or about 35 to 45 wt %, and wherein the weight percentage of PA6,66 is at or about 5 to 65 wt %, preferably at or about 10 to 50 wt %, more preferably at or about 15 to 40 wt %, wherein these weight percentages are based on the total weight of polymers in the barrier resin.

The barrier resin (particularly a vinyl alcohol containing polymer or copolymer), including any compatibilizers, is preferably present at or about 2 to 30 wt %, more preferably at or about 3 to 15 wt %, particularly preferably at or about 5 to 10 wt %, or 7 to 9 wt % based on the total weight of the barrier resin and polyolefin resin in the blend of the invention.

The polyolefin is preferably present in the composition at or about 55 to 97 wt %, more preferably at or about 85 to 96 wt %, particularly preferably at or about 83 to 94 wt %, based on the total weight of polymers in the blend of the invention.

In the method according to the invention, the temperature of the melt throughout the extruder is controlled to be not higher than at or about 10° C. above the melting point of the barrier resin. While not wishing to be limited by theory, the inventors believe that such a temperature profile results in just barely melting the barrier resin, allowing a laminar structure to be formed with the olefin resin. The melting point of the barrier resin may be determined according to ISO 11357-3:1999(E). The temperature of the melt should not be lower than the melting point of the barrier resin.

Particularly preferred are the following barrier resins: A barrier resin consisting of an ethylene-vinyl alcohol copolymer (EVOH), with at or about 26 mol % of repeat units derived from ethylene and at or about 74 mol % derived from vinylalcohol, and the following compatibilizers: maleic anhydride grafted HDPE, or maleic anhydride grafted ethylene propylene diene (EPDM). This barrier resin has a melting point of approximately 195° C.

A barrier consisting of polyvinyl alcohol (PVOH) (47.75 wt %) mixed with copolymer PA6,66 (18.6 wt %) and the following compatibilizers: maleic anhydride grafted HDPE, or maleic anhydride grafted ethylene propylene diene (EPDM). This barrier resin has a melting point of approximately 225° C.

The thermoplastic polymer blends made using the method of the invention can be injection- or blow-molded, or extruded. A preferred use for thermoplastic polymer blends made using the method of the invention is blow-molded articles, for example, bottles, canisters, reservoirs or tanks. In a particularly preferred embodiment, the thermoplastic polymer blend made with the method of the invention is used to make fuel or solvent reservoirs, such as a heating oil tank, an automotive fuel tank, an antifreeze reservoir, a motorcycle fuel tank, and a jerrycan.

In another preferred embodiment, the thermoplastic polymer blend may be extruded, particularly for making hollow articles, such as pipes.

Thermoplastic polymer blends compounded by the method of the invention and molded, particularly blow-molded, or extruded, particularly into hollow articles, have a laminar structure that can be observed under an optical microscope. Using the method of the invention, thermoplastic polymer blends are produced wherein the laminar structure has an aspect ratio of greater than at or about 10, preferably between at or about 10 to 10,000, more preferably greater than at or about 20, particularly preferably greater than at or about 35, even more particularly preferably greater than at or about 50. The aspect ratio can be measured using microtoming procedure, followed by image analysis. In particular, the molded resin is sliced laterally across the direction of elongation during molding (e.g. a cross-section of the wall of a blow-molded article) into slices of 10 to 20 micrometer thickness. The slices may be stained with iodine to increase contrast, and they are then examined at a suitable magnification (e.g. 50 to 100×), and the aspect ratio determined by calculation from the lamellae thickness assuming that the initial volume of the pellet remains constant. A schematic of microtomes of polymer blends is shown in FIG. 5. “AR” in FIG. 5 lists the measured Aspect Ratio for more than 80% of the lamellae. AR is calculated as the length of a lamella (“L”) divided by its thickness (“T”), as indicated in FIG. 5. The top row of FIG. 5 shows schematically a microtome of HDPE without any barrier resin. There are no lamellae and barrier properties are very low. Moving downward, the middle row of FIG. 5 shows a schematic of a microtome when the mixing is according to the method of the invention. Lamellae are thin (50<AR<10,000), and barrier properties are excellent. The bottom row shows a schematic of a microtome in which the melt temperature was too high (“comparative”). Lamellae are poorly formed (1<AR<30), and barrier properties are poor. When the aspect ratio is lower than 10, the barrier properties of the thermoplastic polymer blend are poor.

Articles made from the thermoplastic polymer blends of the invention have enhanced barrier properties as compared with articles made with conventional thermoplastic polymer blends. The barrier properties extend to hydrocarbons, particularly straight-chain and branched hydrocarbons (e.g. C₁-C₁₈, particularly C₅-C₁₂), m- p- and o-xylene, ethanol, benzene, ethylbenzene, toluene, ethyl-benzene, methanol, and methyl-t-butyl ether (MTBE). Also included are halogenated hydrocarbons and oxygen containing hydrocarbons, such as alcohols, CE10 type fuel and mixtures of all of these. Barrier properties may be measured by determining permeability to various solvents, for example, according to ASTM D2684. When measured according to this standard, molded and extruded articles (particularly blow-molded articles) preferably have permeabilities to hydrocarbons or C-fuel type containing alcohol of less than at or about 0.0787 g·mm/day·100 cm² when measured after 3, 4, 5 or 6 weeks soaking, at a steady-state of mass transfer of hydrocarbon, more preferably less than at or about 0.04 g·mm/day·100 cm², particularly preferably less than at or about 0.02 g·mm/day·100 cm².

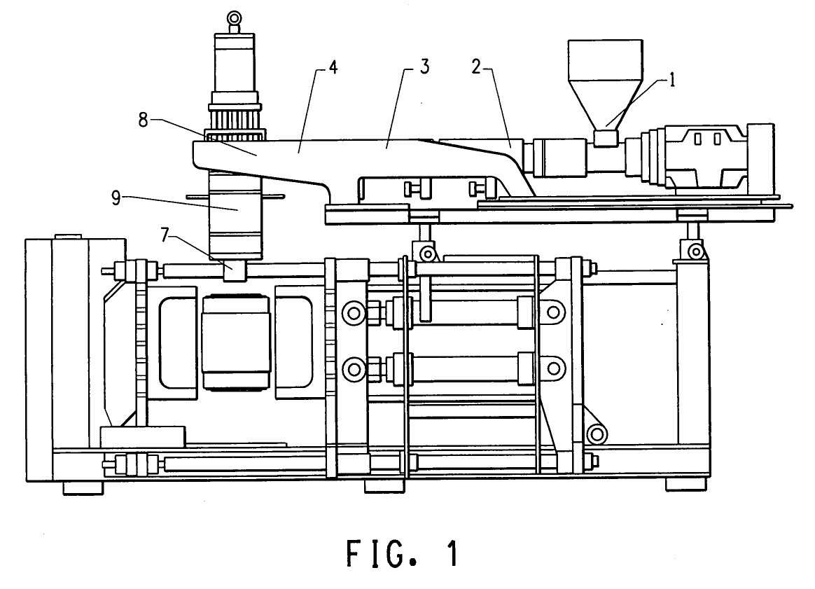

A schematic of an extrusion blow-molding machine is shown in FIG. 1. Solid thermoplastic polymer material (both olefin resin and barrier resin) is fed into the hopper (1). It passes into the rear (2) of the barrel, past the middle (3) and front (4) of the barrel, before passing the adaptor and being extruded at the crosshead (9), through the die (7) of the crosshead. The temperature may be measured by a thermocouple probe at certain points along the extruder, including at the crosshead (8) [T_{coupling}] and at the crosshead die (7) [Tₘₑₗₜ]. In a particularly preferred embodiment of the method of the invention, the thermoplastic polymer material (i.e. olefin resin and barrier resin) is heated to at or about 0-10° C. (more preferably 0-5° C.) above the melting point of the barrier resin at the rear of the screw, and rises as the thermoplastic polymer material passes down the barrel to at or about 10° C. above the melting point of the barrier resin when the thermoplastic polymer blend reaches the die. In a particularly preferred embodiment, the temperature of the thermoplastic polymer material (i.e. olefin resin and barrier resin) is heated to at or about the melting point of the barrier resin at the rear of the barrel of the extruder, and maintained relatively constant through the barrel until the front of the barrel. There is then a temperature gradient whereby the temperature is raised from at or about the melting point of the barrier resin at the front of the barrel to at or about 10° C. above the melting point of the barrier resin at the die. The expression “front” in respect to the barrel of an extruder is meant to include the volume within at or about the last 30% of the length of the barrel before the die. The expression “rear” in respect to the barrel of an extruder is meant to include the volume within at or about the first 30% of the length of the barrel after the hopper.

Alternatively, the temperature of the thermoplastic polymer material at the rear of the extruder may be maintained at or about 5-20° C. below, preferably 5-15° C. below, the melting point of the barrier resin. The temperature of the thermoplastic polymer material is then gradually raised as it passes through the extruder, until it is at or about 0-10° C. above the melting point of the barrier resin at the die.

The expression “rear” means at or about the first 30-40 cm after entry of polymer material into the barrel of the extruder. Similarly, the expression “front” means at or about the last 30-40 cm of the barrel, before entry of the polymer into the die.

### EXAMPLE 1

Thermoplastic polymer blends were made comprising HDPE as olefin resin with a barrier resin was incorporated at 7 wt %. The barrier resin was a copolymer of ethylene and vinylalcohol, with 26 mol % of repeat units derived from ethylene and about 74 mol % of repeat units derived from vinyl alcohol, and a melt flow rate measured at 210° C. under 2160 g of 3.2 g/10 minutes. The resin includes maleic anhydride grafted HDPE, or maleic anhydride grafted ethylene propylene diene (EPDM). The melting point of the barrier resin was 195° C.

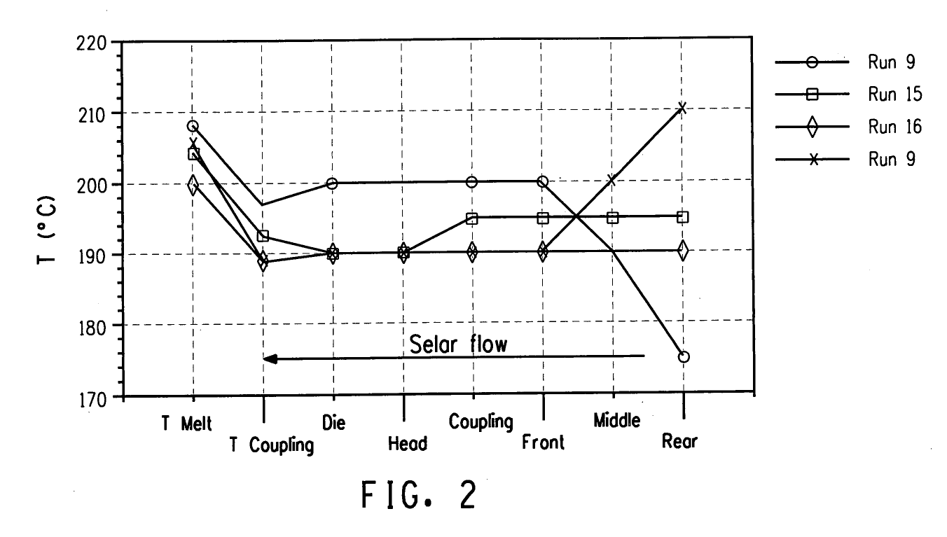

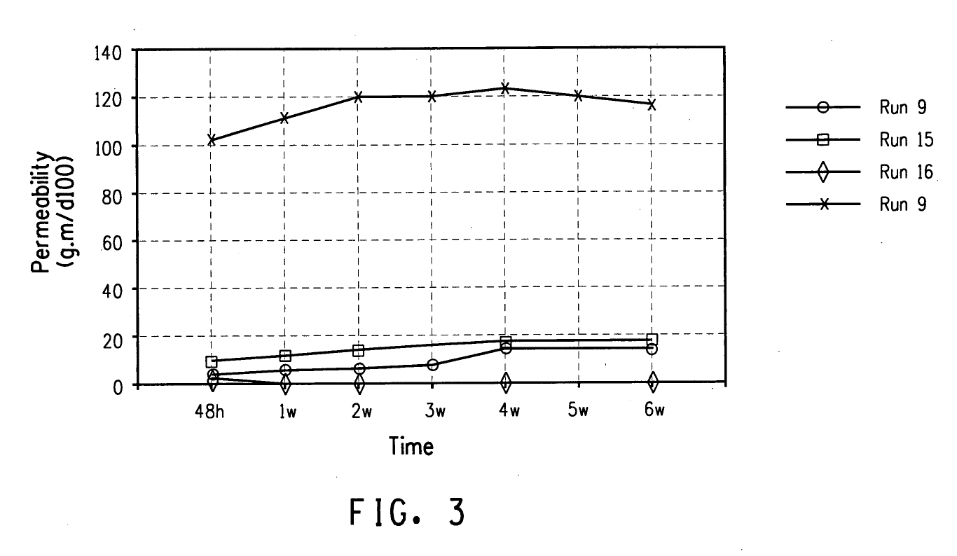

The dry resins were mixed as granules in the hopper of an extruder, and then passed through the extruder with the temperature profiles shown in FIG. 2. The points where temperature of the extruder was set are indicated in FIG. 1 as rear (2), middle (3), front (4), coupling (8), head (9) and die (7). These points on FIG. 2 (rear, middle, front, coupling, head and die) are the values at which the temperature control of the extruder was set. The temperature of the thermoplastic polymer material was actually measured at coupling (8) and the die (7), and these measured values are the points indicated as T_{coupling} and Tₘₑₗₜ, respectively.

For run 20, which is shown for comparative purposes, thermoplastic polymer blend at the rear of the extruder was heated to 15° C. above the melting point of the barrier resin. It was then allowed to cool to approximately the melting point of the barrier resin while passing through the extruder.

Runs 9, 15 and 16, are according to the method of the invention.

For run 9, the temperature at the rear of the extruder was maintained at approximately 175° C., i.e. approximately 20° C. below the melting point of the barrier resin (195° C.). It was then raised from the rear to the middle of the barrel to approximately 200° C. (i.e. approximately 5° C. above the melting point of the barrier resin), and maintained at 200° C. as it passed through the barrel.

For run 15, the temperature at the rear of the extruder was maintained at approximately 195° C., i.e. at the melting point of the barrier resin. It was allowed to cool somewhat as it passed down the barrel, to approximately 190° C.

For run 16, the temperature at the rear of the extruder was maintained at approximately 190° C., i.e. slightly below the melting point of the barrier resin. It was maintained at this temperature throughout the barrel.

The blends produced from comparative run 20 and invention runs 9, 15 and 16 were blow-molded to produce a standard test bottle of 1.5 litre, with an external area of 645 cm² (100 inch²) and a wall thickness of 1.4 mm. The blow-molded bottles were tested for permeability to CE10 type fuel (i.e. a mixture of 45 vol % isooctane, 45 vol % toluene and 10 vol % ethanol), over time, according to ASTM D2684.

Permeability, P, is calculated according to the following equation:

$$P = \frac{( R \cdot t )}{A}$$

wherein R is the rate of loss of hydrocarbon (in g/day), t is the wall thickness (in mm), and A is the external area (in cm²).

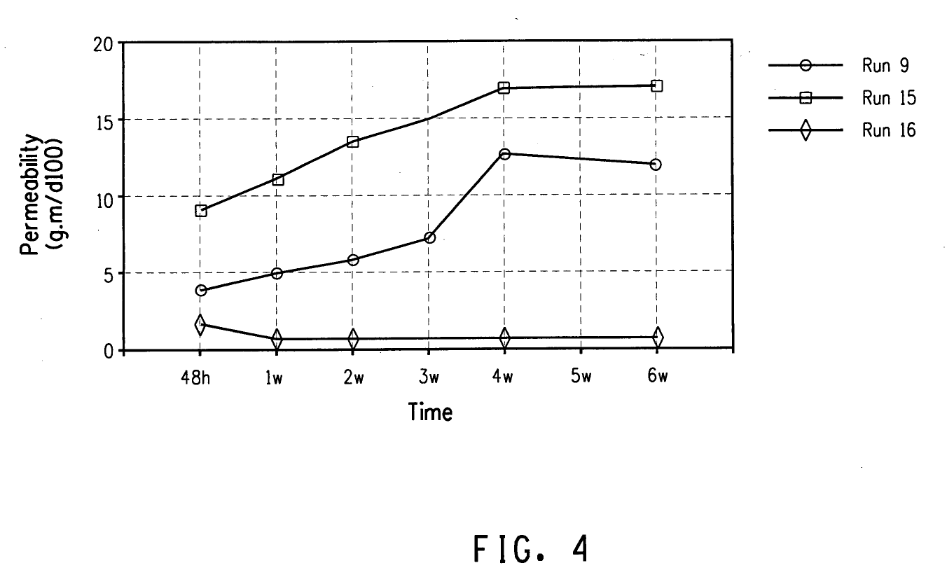

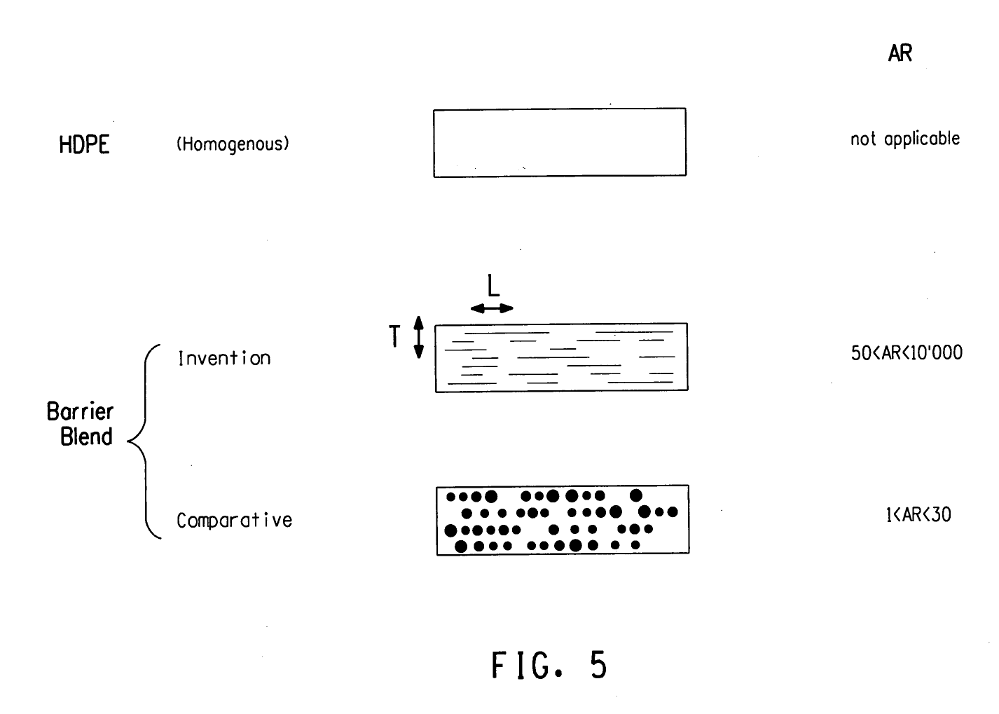

The results are shown in FIG. 3, and enlarged in FIG. 4. It can be seen that bottles made from thermoplastic polymers blended in runs 9, 16 and 16 (invention), have a permeability to CE10 type fuel after 48 hours (steady state of mass transfer) of 0.0354, 0.0157 and 0.00787 g·mm/day·100 cm², respectively, whereas bottles made from thermoplastic polymer blended in run 20 (comparative) have a permeability to CE10 type fuel after 48 hours of over 0.393 g·mm/day·100 cm² (i.e. a 10- to 50-fold decrease in permeability is obtained by using the method of the invention). Permeability results are further listed in Table 1.

TABLE 1
Permeability (g · mm/day · 100 cm²) as measured according
to ASTM D2684 for blow-molded standard test bottles made from
thermoplastic polymer material (HDPE and barrier resin, blended
according to comparative run 20 and runs 9, 15 and 16

| | Time | | | | | |
|---|---|---|---|---|---|---|
| | 48 h | 1 week | 2 weeks | 3 weeks | 4 weeks | 6 weeks |
| Comparative | 0.402 | 0.433 | 0.472 | 0.468 | 0.484 | 0.461 |
| run 20 | | | | | | |
| Run 9 | 0.015 | 0.019 | 0.022 | 0.028 | 0.051 | 0.048 |
| Run 15 | 0.036 | 0.044 | 0.054 | 0.059 | 0.067 | 0.067 |
| Run 16 | 0.0079 | 0.0028 | 0.0024 | 0.0028 | 0.0028 | 0.0024 |

What is claimed is:

1. A method for producing a thermoplastic polymer blend having barrier properties to hydrocarbons, the method comprising the steps:
blending in an extruder thermoplastic polymer material comprising or consisting essentially of an olefin resin, and a barrier resin selected from polyvinyl alcohol, copolymers of ethylene-vinyl alcohol, polyamides, and mixtures of these, wherein the temperature of the thermoplastic polymer material in the extruder is not higher than at or about 10° C. above the melting point of the barrier resin.

2. The method of claim 1, wherein the olefin resin is selected from high-density polyethylene, low-density polyethylene and polypropylene.

3. The method of claim 1, wherein the barrier resin is an ethylene-vinyl alcohol copolymer.

4. The method of claim 1, wherein the barrier resin is PA6.

5. The method of claim 1, wherein the barrier resin is a copolymer of PA6,66.

6. The method of claim 1, wherein the barrier resin is a mixture of polyvinyl alcohol and PA6,66.

7. The method of claim 1, wherein the barrier resin is present at or about 5-15 wt % based on the total weight of polymers in the blend.

8. The method of claim 1, wherein the thermoplastic polymer material is heated to at or about 0-10° C. above the melting point of the barrier resin at the rear of the barrel of the extruder, and rises as the thermoplastic polymer material passes down the barrel of the extruder to at or about 10° C. above the melting point of the barrier resin when the thermoplastic polymer blend reaches the die of the extruder.

9. The method of claim 1, wherein the hydrocarbon is selected from straight-chain and branched hydrocarbons (e.g. C₅-C₁₈), xylene, ethanol, benzene, toluene, ethyl-benzene, methanol, and methyl-t-butyl ether (MTBE), CE10 type fuel, and mixtures of these.

10. A molded or extruded article comprising or consisting essentially of a thermoplastic polymer blend comprising or consisting essentially of a polyolefin and a barrier resin selected from polyvinyl alcohol, copolymers of ethylene-vinyl alcohol, polyamides, and mixtures of these, wherein the molded or extruded article has a permeability to hydrocarbons at a wall thickness (t) of 1.4 mm, and an external area (A) of 645 cm², of less that at or about 0.0787 g·mm/day·100 cm², when a steady rate of mass transfer of hydrocarbon is reached, as measured according to ASTM D2684 [fuel type CE10; temperature 40° C.].

11. The molded or extruded article of claim 10, wherein the olefin resin is selected from high-density polyethylene, low-density polyethylene and polypropylene.

12. The molded or extruded article of claim 10, wherein the barrier resin is an ethylene-vinyl alcohol copolymer.

13. The molded or extruded article of claim 10, wherein the barrier resin is PA6.

14. The molded or extruded article of claim 10, wherein the barrier resin is a copolymer of PA6,66.

15. The molded or extruded article of claim 10, wherein the barrier resin is a mixture of polyvinyl alcohol and PA6,66.

16. The molded or extruded article of claim 10, wherein the barrier resin is present at or about 7-9 wt %.

17. The molded or extruded article of claim 10, which is a blow-molded article.

18. The molded or extruded article of claim 10, which is an extruded article.

19. A molded or extruded article comprising or consisting essentially of a thermoplastic polymer blend comprising or consisting essentially of a polyolefin and a barrier resin selected from polyvinyl alcohol, copolymers of ethylene-vinyl alcohol, polyamides, and mixtures of these, wherein the molded or extruded article has a laminar microstructure exhibiting an aspect ratio of greater than at or about 10.

20. The molded or extruded article of claim 19, wherein the aspect ratio is greater than at or about 50.

21. A molded or extruded article obtained by a method comprising a step of blending in an extruder thermoplastic polymer material comprising or consisting essentially of an olefin resin and a barrier resin selected from polyvinyl alcohol, copolymers of ethylene-vinyl alcohol and polyamides, and mixtures of these, wherein the temperature of the thermoplastic polymer material in the extruder is controlled to be not higher than at or about 10° C. above the melting point of the barrier resin.

22. A method for producing a molded or extruded article comprising a thermoplastic polymer blend having barrier properties to hydrocarbons, the method comprising the steps:
blending in an extruder thermoplastic polymer material comprising or consisting essentially of an olefin resin, and a barrier resin selected from polyvinyl alcohol, copolymers of ethylene-vinyl alcohol, polyamides, and mixtures of these; and
molding or extruding the thermoplastic polymer material;
wherein the temperature of the thermoplastic polymer material in the extruder is controlled to be not higher than at or about 10° C. above the melting point of the barrier resin.

23. The method of claim 22, wherein the olefin resin is selected from high-density polyethylene, low-density polyethylene and polypropylene.

24. The method of claim 22, wherein the barrier resin is an ethylene vinylalcohol copolymer.

25. The method of claim 22, wherein the barrier resin is PA6.

26. The method of claim 22, wherein the barrier resin is a copolymer of PA6,66.

27. The method of claim 22, wherein the barrier resin is a mixture of polyvinyl alcohol and PA6,66.

28. The method of claim 22, wherein the barrier resin is present at or about 4-20 wt %.

29. The method of claim 22, which is for making a blow-molded article, comprising the step of blow-molding.

30. The method of claim 22, which is for making a hollow extruded article, comprising a step of extrusion.
